(19) United States
(12) Patent Application Publication
(10) Pub. No.: US 2017/0113607 A1
(43) Pub. Date: Apr. 27, 2017

(54) ON VEHICLE OVERWEIGHT SYSTEM DETECTOR

(71) Applicant: Continental Automotive Systems, Inc., Auburn Hills, MI (US)

(72) Inventors: Ulises Corrales Salgado, Zapopan (MX); David Cruz Mendez, Zapopan (MX); Hector Manuel Davalos Rodriguez, Zapopan (MX)

(21) Appl. No.: 14/923,251

(22) Filed: Oct. 26, 2015

(51) Int. Cl. B60Q 9/00; G01G 19/02

(52) U.S. Cl. CPC B60Q 9/00; G01G 19/021; G01G 19/024

(57) ABSTRACT

A disclosed vehicle information system includes a controller configured to receive information indicative of a weight of at least a portion of a vehicle and a communication device disposed within the vehicle cabin for communicating a recommended limit of a vehicle operating parameter based on weight of at least a portion of the vehicle. The system provides for communicating a determined range of vehicle operating parameters to an operator within the vehicle cabin with a communication device such that the operator understands the modified limits of the vehicle based on the current measured vehicle weight.

### TECHNICAL FIELD

The present disclosure relates to an information system for communicating optimal driving parameters to a vehicle operator.

### BACKGROUND

Vehicle performance is contingent on many variable factors including weight. Vehicle weight may vary based on load, fuel, number of passengers along with many other variables. An operator may not be specifically aware of the limitations placed on vehicle performance due to the weight and therefore may operate the vehicle in a manner not recommended for the weight and load. However, systems that override operator input to limit operation of a vehicle are often not favorably viewed by a consumer.

### SUMMARY

A disclosed example embodiment of a vehicle information system includes a controller configured to receive information indicative of a weight of at least a portion of a vehicle and a communication device disposed within the vehicle cabin for communicating a recommended limit of a vehicle operating parameter based on weight of at least a portion of the vehicle.

Another disclosed example embodiment includes a method of communicating vehicle operating parameters to a vehicle operator. The method includes generating a signal indicative of a measured weight of at least a portion of the vehicle and determining a range of vehicle operating parameters based on the measured weight with a controller located within the vehicle. The method further includes the step of communicating the determined range of vehicle operating parameters to an operator within the vehicle cabin with a communication device such that the operator understands the modified limits of the vehicle based on the current measured vehicle weight.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic representation of a vehicle including a load.

FIG. 2 is a schematic representation of a vehicle cabin.

FIG. 3 is a schematic representation of an instrument panel within the vehicle.

FIG. 4 is a schematic representation of different displays provided by a digital display of the example instrument panel.

### DETAILED DESCRIPTION

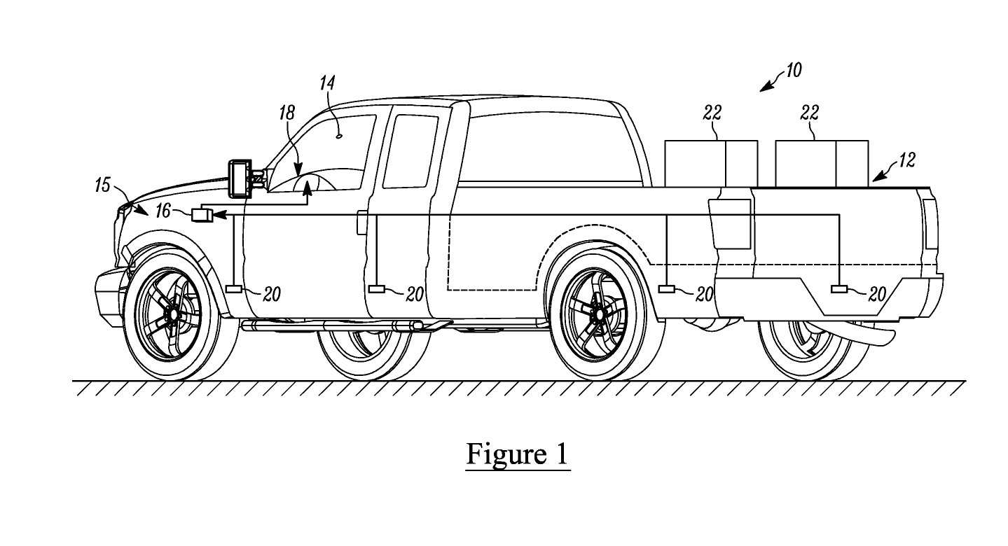

Referring to FIG. 1, a vehicle 10 includes a cargo area that in this example is a pickup truck bed 12. The truck bed 12 is often utilized to carry loads and other cargo schematically illustrated at 22. The weight of the load 22 within the vehicle 10 will affect performance of the vehicle and may limit maximum recommended vehicle performance. As appreciated, a heavily loaded vehicle may limit the maximum safe speed, as well as stopping distance and grade that the vehicle is capable of travelling. In some instances, a load within a vehicle will substantially limit the range of safe operating parameters such as vehicle speed. As appreciated, as the vehicle becomes heavier with an increased load, the maximum safe speed may be reduced as well as the minimum stopping distance of the vehicle. Moreover, it should be understood, that although a pickup truck is illustrated by way of example, any vehicle such as a passenger car or commercial truck could benefit from the disclosures provided herein.

The example vehicle 10 includes a vehicle information system 15 that provides information on safe operating parameters for a vehicle based on a weight of the vehicle. The example system includes a controller 16 that receives information from various sensors 20 disposed within the vehicle. The sensors 20 provide signals indicative of the vehicle weight for at least a portion of the vehicle. In one example, the sensors 20 provide information to the controller 16 that are indicative of the load 22 within the truck bed 12. As appreciated although in this example the load 22 is within the truck bed 12, the example system may measure loads within the vehicle cabin and or other parts of the vehicle depending on the specific vehicle configuration. Moreover in another example, the sensors 20 provide information indicative of entire weight of the vehicle that is utilized by the controller 16.

The controller 16 utilizes information indicative of vehicle weight or weight of at least portions of the vehicle including the load 22 within the truck bed 12 to determine and communicate information pertaining to recommended limits on vehicle operating parameters. Vehicle operating parameters can include vehicle speed, minimum-stopping distance, turning radius, maximum grade, as well as other vehicle performance and operating characteristics that can alter vehicle performance.

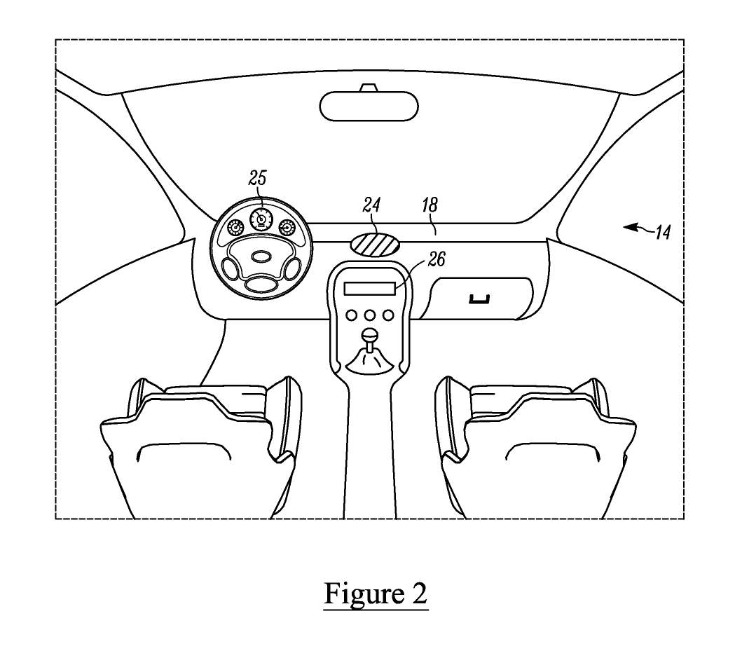

Referring to FIG. 2, with continued reference to FIG. 1, the example system 15 utilizes the information from the weight sensors 20 disposed within the vehicle 10 to generate a signal or otherwise communicate to a vehicle operator recommended vehicle-operating limits based on the weight measured by the sensors 20. In this example, the controller 16 communicates with a communication device that is disposed within the vehicle cabin 14. The communication device can include portions of instrument panel 25, a digital display 26, or a noise generating device such as a speaker 24.

The controller 16 determines limits on vehicle operating parameters based on the measured weight provided by the sensors 20. The controller 16 then generates a signal that communicates the recommended vehicle operating parameters to the vehicle operator. Communication to the vehicle operator can be in several forms. In one embodiment, the form is through an audible means where the controller 16 will initiate the generation of an audible signal through the speaker 24 to indicate that the vehicle is approaching a recommended limit based on the measured weight. The audible signal can be in the form of a voice indicating that a maximum speed or other vehicle operating parameter limit is being reached or may be a series of beeps or other noise that either increases in frequency or become louder as a recommended limit is approached.

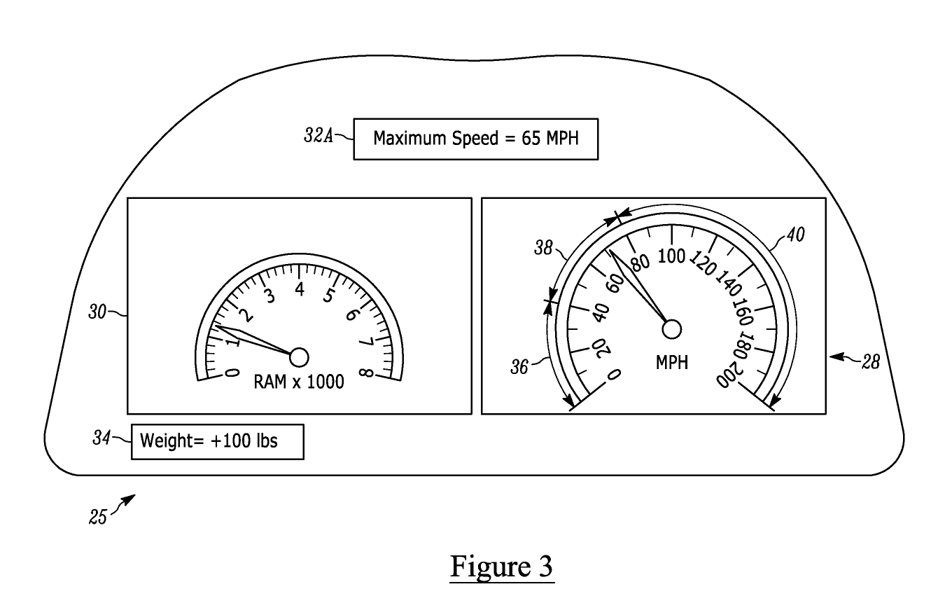

Referring to FIG. 3, with continued reference to FIGS. 1 and 2, the vehicle instrument panel 25 is illustrated and includes a speedometer 28 and an Engine RPM speed gauge 30. In this embodiment, the speedometer 28 includes regions 36, 38 and 40 that change color to communicate various ranges or vehicle speed recommended based on the vehicle's current measured weight. In this example, the first range 36 indicates a green or acceptable speed area. A second range 38 indicates an approach toward the maximum speed and a third area 40 is indicative of a speed that is beyond the maximum recommended speed. Each of the ranges may be color coded or otherwise changed visually to communicate information of the maximum speed recommended based on the measured vehicle weight.

The instrument panel 25 further includes a display 32A. The display 32A can be utilized and controlled to display a maximum speed that is determined by the controller 16 based on the measured weight. The instrument panel 25 may also include a display 34 that displays a reading of the weight. In this example, the vehicle weight is indicated as an amount over a normal level. In the illustrated example, the weight is illustrated as an amount over the normal level or acceptable weight that does not limit vehicle operation. It should be appreciated that it is within the contemplation of this disclosure, that the weight provided in the display 34 could be displayed as a total weight or as simply a weight of the load 22 within the bed 12. Moreover, the display may also simply provide a text message that indicates that the vehicle is currently loaded to a condition that limits vehicle operation.

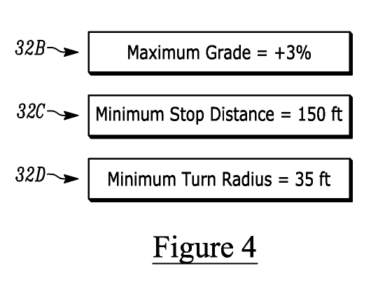

Referring to FIG. 4, with continued reference to FIG. 3, the display 34 provided in the instrument panel 25 could also be utilized to display other vehicle operating parameters that are limited by an increase in vehicle weight. In one example illustrated at 32B, the maximum grade that the vehicle is capable of ascending can be displayed. Moreover, the display as is indicated at 32C could be utilized to display a message communicating a maximum stopping distance to an operator. In another example indicated at 32D a minimum turning radius is communicated based on the measured weight of the vehicle.

The example system 15 communicates information indicative of limits on a vehicle based on measured weight. The measured weight can be of the entire vehicle 10 or only specific portions of it such as the load 22 disposed within the truck bed 12. The system 15 provides only recommendations based on the measured weight and does not intrude on vehicle operation. As appreciated, in some instances an operator may not be aware that a vehicle is loaded to an extent where certain vehicle operating parameters should be limited to remain within a desired range of safe operation. Therefore, the example system 15 utilizes information on vehicle weight that is obtained from the sensors 20 throughout the vehicle to communicate to an operator recommended limits on vehicle operation such that the operator will have information needed to safely operate and control the vehicle. Moreover, although specific examples of communication devices for communicating information to a vehicle operator are illustrated. Other communication devices or means are also within the contemplation of this disclosure.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A vehicle information system comprising:
a controller configured to receive information indicative of a weight of at least a portion of a vehicle; and
a communication device disposed within the vehicle cabin for communicating a recommended limit of a vehicle operating parameter based on weight of at least a portion of the vehicle.

2. The vehicle information system as recited in claim 1, including at least one sensor configured for sensing a weight of at least a portion of the vehicle.

3. The vehicle information system as recited in claim 2, wherein the at least one sensor is configured to provide a signal indicative of a weight of a load placed in the vehicle.

4. The vehicle information system as recited in claim 2, wherein the at least one sensor is configured to provide a signal indicative of a weight of the entire vehicle including a load placed in the vehicle.

5. The vehicle information system as recited in claim 1, wherein the communication device comprises a display visible within the vehicle cabin.

6. The vehicle information system as recited in claim 1, wherein the communication device comprises a speedometer indicating vehicle speed including a graphical representation of a recommended speed limit of the vehicle based on the weight of at least a portion of the vehicle.

7. The vehicle information system as recited in claim 1, wherein the communication device comprises a portion of a vehicle instrument panel including a digital display, wherein the digital display is configured to display a recommended maximum speed of the vehicle based on the weight of at least a portion of the vehicle.

8. The vehicle information system as recited in claim 1, wherein the communication device comprises an audible alert device configured to emit an audible alert signal that is activated upon nearing a recommended maximum speed based on weight of at least a portion of the vehicle.

9. The vehicle information system as recited in claim 1, wherein the vehicle operating parameter comprises one of a vehicle speed, minimum stopping distance, hill grade, and turning radius.

10. A method of communicating vehicle operating parameters to a vehicle operator, the method comprising:
generating a signal indicative of a measured weight of at least a portion of the vehicle;
determining a range of vehicle operating parameters based on the measured weight with a controller located within the vehicle; and
communicating the determined range of vehicle operating parameters to an operator within the vehicle cabin with a communication device.

11. The method as recited in claim 10, including generating a signal indicative of a measured weight of the vehicle with a sensor and sending the signal to the controller.

12. The method as recited in claim 11, wherein the measured weight comprises a weight of a load placed within the vehicle.

13. The method as recited in claim 11, wherein the measured weight comprises a weight of the entire vehicle.

14. The method as recited in claim 11, wherein the communication device comprises a speedometer disposed within the vehicle cabin and the vehicle operating parameter comprises a maximum recommended speed of the vehicle based on the measured weight.

15. The method as recited in claim 11, wherein the communication device comprises a digital display disposed within the vehicle cabin and the vehicle operating parameter comprises a maximum recommended speed for the measured weight displayed on the digital display.

16. The method as recited in claim 11, wherein the communication device comprises an audible device actuatable to generate an audible signal responsive to a vehicle operating parameter approaching a recommended maximum value.

17. The method as recited in claim 11, wherein the vehicle operating parameter comprises at least one of a vehicle speed, minimum stopping distance, hill grade, and turning radius.
